(19) United States
(12) Patent Application Publication
(10) Pub. No.: US 2017/0291795 A1
(43) Pub. Date: Oct. 12, 2017

(54) MOBILE CALL MODIFY

(71) Applicant: Otis Elevator Company, Farmington, CT (US)

(72) Inventors: Bradley Armand Scoville, Farmington, CT (US); Paul A. Simcik, Southington, CT (US)

(21) Appl. No.: 15/091,935

(22) Filed: Apr. 6, 2016

(51) Int. Cl. B66B 1/46; B66B 1/24

(52) U.S. Cl. CPC B66B 1/468; B66B 1/2408; B66B 2201/4653; B66B 2201/103; B66B 2201/4615

(57) ABSTRACT

A system and a method of modifying an elevator call with a mobile device is provided. The method includes sending, to an elevator controller, a first input wherein the first input is a first elevator call, calling, using the elevator controller, an elevator based on the first elevator call and the mobile device, sending, using the mobile device, a second input, wherein the second input is a modify command, and modifying, using the elevator controller, the first elevator call based on the modify command.

### TECHNICAL FIELD

The subject matter disclosed herein generally relates to controlling elevator calls, and more specifically, controlling elevator calls using mobile devices.

### DESCRIPTION OF RELATED ART

A user can call an elevator by pushing a button in an elevator lobby or by entering an elevator call using a kiosk or the like. Once a user enters a call request, that request remains active until the elevator arrives, opens, and waits for a predetermined time. In some elevator systems, a user may even place an elevator call using a portable device such as a mobile phone.

However, if a user changes their mind, or erroneously entered the request, the call typically must still fully execute. For example, if a user pushes a down call button, the call is entered and an elevator is queued and dispatched towards that user. If the user then decides that they would rather travel up and presses that indicator, the original call requests for an elevator going down remains.

As a result, passengers may make extra calls and elevators are not utilized to their maximum potential, together degrading system performance. Accordingly, there exists a desire for improved elevator call control using a mobile device.

### SUMMARY

According to one embodiment a method of modifying an elevator call with a mobile device is provided. The method includes sending, to an elevator controller, a first input wherein the first input is a first elevator call, calling, using the elevator controller, an elevator based on the first elevator call and the mobile device, sending, using the mobile device, a second input, wherein the second input is a modify command, and modifying, using the elevator controller, the first elevator call based on the modify command.

In addition to one or more of the features described above, or as an alternative, further embodiments may include wherein the first input from a user is received using at least one from a group consisting of the mobile device, a kiosk, a web portal, and a detected input within a building using building sensors.

In addition to one or more of the features described above, or as an alternative, further embodiments may include wherein the modify command includes a floor change.

In addition to one or more of the features described above, or as an alternative, further embodiments may include wherein the modify command includes a call cancellation.

In addition to one or more of the features described above, or as an alternative, further embodiments may include, wherein the modify command includes one or more of a call delay, a party number adjustment, a priority adjustment, a load size requirement adjustment, and a weight adjustment.

In addition to one or more of the features described above, or as an alternative, further embodiments may include wherein modifying the first elevator call includes deleting the first elevator call from a dispatching queue in the elevator controller.

In addition to one or more of the features described above, or as an alternative, further embodiments may include wherein modifying the first elevator call includes modifying the first elevator call placement in a dispatching queue in the elevator controller.

In addition to one or more of the features described above, or as an alternative, further embodiments may include wherein modifying the first elevator call includes modifying one or more fields in the first elevator call while maintaining position of the first elevator call in a dispatching queue in the elevator controller.

In addition to one or more of the features described above, or as an alternative, further embodiments may include, further including notifying a user, using the mobile device, of an ability to modify the first elevator call.

In addition to one or more of the features described above, or as an alternative, further embodiments may include, further including notifying a user, using the mobile device that modifying the first elevator call is complete.

In addition to one or more of the features described above, or as an alternative, further embodiments may include, further including notifying a user, wherein notifying includes generating a graphical user interface (GUI) that includes a modification notification and modification input fields, wherein the modification notification includes at least one from a group consisting of a word, phrase, graphic, symbol, and image, and wherein the modification input fields includes at least one from a group consisting of hyperlinked text, input buttons, and input fields, and displaying the GUI on the mobile device.

According to one embodiment a system for modifying an elevator call with a mobile device is provided. The system includes an elevator controller configured to receive a first input, wherein the first input is a first elevator call, and a second input, wherein the second input is a modify command, process the first input and second input, and transmit commands to an elevator based on the first input and the second input, and a mobile device including an input device configured to receive the second input, and a transmitter configured to transmit the second input, and the elevator configured to receive the commands from the elevator controller and move in accordance with the received commands.

In addition to one or more of the features described above, or as an alternative, further embodiments may include, wherein the first input from a user is received using at least one from a group consisting of the mobile device, a kiosk, a web portal, and a detected input within a building using building sensors.

In addition to one or more of the features described above, or as an alternative, further embodiments may include, wherein the modify command includes a floor change.

In addition to one or more of the features described above, or as an alternative, further embodiments may include wherein the modify command includes a call cancellation.

In addition to one or more of the features described above, or as an alternative, further embodiments may include, wherein the modify command includes one or more of a call delay, a party number adjustment, a priority adjustment, a load size requirement adjustment, and a weight adjustment.

According to one embodiment a computer program product for modifying an elevator call is provided. The computer program product including a computer readable storage medium having program instructions embodied therewith, the program instructions executable by a processor to cause the processor to receive, at an elevator controller, a first input, wherein the first input is a first elevator call, call, using the elevator controller, an elevator based on the first elevator call and the mobile device, receive, using the mobile device, a second input, wherein the second input is a modify command, and modify, using the elevator controller, the first elevator call based on the modify command.

In addition to one or more of the features described above, or as an alternative, further embodiments may include the computer program product including additional program instructions executable by the processor to cause the processor to delete the first elevator call from a dispatching queue in the elevator controller.

In addition to one or more of the features described above, or as an alternative, further embodiments may include, the computer program product including additional program instructions executable by the processor to cause the processor to modify one or more fields in the first elevator call while maintaining position of the first elevator call in a dispatching queue in the elevator controller.

In addition to one or more of the features described above, or as an alternative, further embodiments may include, the computer program product including additional program instructions executable by the processor to cause the processor to notify a user, wherein notifying includes generating a graphical user interface (GUI) that includes a modification notification and modification input fields, wherein the modification notification includes at least one from a group consisting of a word, phrase, graphic, symbol, and image, and wherein the modification input fields includes at least one from a group consisting of hyperlinked text, input buttons, and input fields, and display the GUI on the mobile device.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 depicts an elevator system in accordance with one or more embodiments of the present disclosure;

FIG. 2 depicts a graphical user interface (GUI) in accordance with one or more embodiments of the present disclosure;

FIG. 3 depicts another GUI in accordance with one or more embodiments of the present disclosure;

FIG. 4 depicts a transmission diagram for controlling an elevator in accordance with the call and modification placed by a mobile device in accordance with one or more embodiments of the present disclosure; and

FIG. 5 depicts a flow diagram of a method of modifying an elevator call with a mobile device in accordance with one or more embodiments of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments described herein are directed to a method and system for mobile elevator call modifications. This system implements a method to modify a previously entered elevator call, which is enabled by a person's personally-held elevator call device. Calls that are placed by the device have an identifier as they pass through the system to the elevator dispatcher. This system provides an option on the graphical user interface of the mobile device for the person to modify their previously entered call. These modification options would be available on the person's mobile graphical interface until the elevator arrives at the person's floor in response to the initial call. In modifying the call to be correct for the person's desired use, including but not limited to cancelling the elevator call, delaying the elevator call, changing the direction desired, or changing the arrival floor desired, dispatching benefits will be realized because the system will not allocate space for a person who does not intend to use the elevator or waste time travelling to the floor originally indicated.

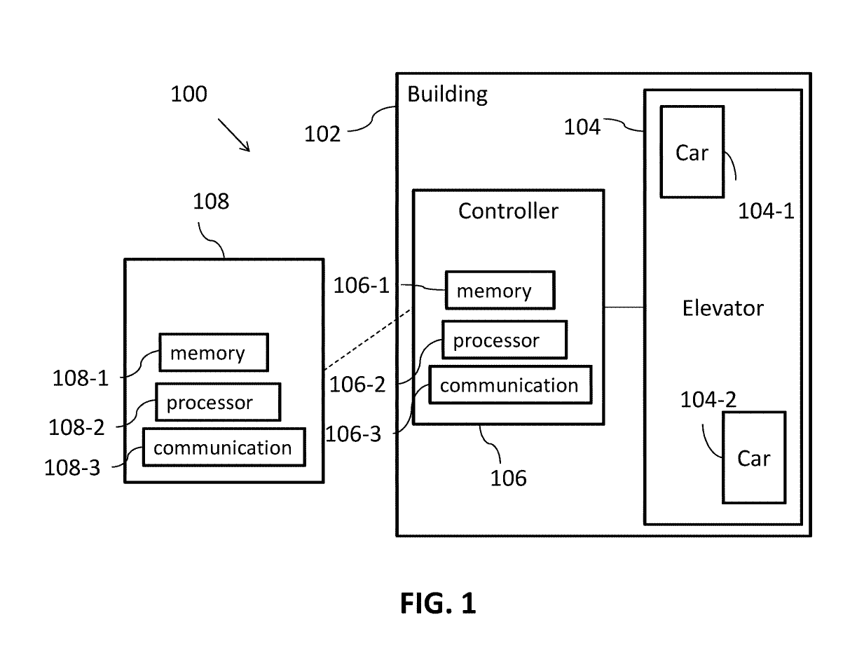

Turning now to the figures, FIG. 1 depicts an elevator system 100 in accordance with one or more embodiments. The elevator system 100 is shown installed at a building 102. In some embodiments, the building 102 may be an office building or a collection of office buildings that may or may not be physically located near each other. The building 102 may include a number of floors. Persons entering the building 102 may enter at a lobby floor, or any other floor, and may go to a destination floor via one or more conveyance devices, such as an elevator 104.

The elevator 104 may be coupled to one or more computing devices, such as a controller 106. The controller 106 may be configured to control dispatching operations for one or more elevator cars (e.g., cars 104-1, 104-2) associated with the elevator 104. The elevator cars 104-1 and 104-2 may be located in the same hoist way or in different hoist ways so as to allow coordination amongst elevator cars in different elevator banks serving different floors. It is understood that other components of the elevator system 100 (e.g., drive, counterweight, safeties, etc.) are not depicted for ease of illustration.

Also shown in FIG. 1 is a mobile device 108. The mobile device 108 may include a device that is typically carried by a person, such as a phone, PDA, electronic wearable, RFID tag, laptop, tablet, watch, or any other known portable mobile device. The mobile device 108 may include a processor 108-2, a memory 108-1, and a communication module 108-3 as shown in FIG. 1. The processor 108-2 can be any type or combination of computer processors, such as a microprocessor, microcontroller, digital signal processor, application specific integrated circuit, programmable logic device, and/or field programmable gate array. The memory 108-1 is an example of a non-transitory computer readable storage medium tangibly embodied in the mobile device 108 including executable instructions stored therein, for instance, as firmware. The communication module 108-3 may implement one or more communication protocols as described in further detail herein.

The controller 106 may include a processor 106-2, a memory 106-1, and communication module 106-3 as shown in FIG. 1. The processor 106-2 can be any type or combination of computer processors, such as a microprocessor, microcontroller, digital signal processor, application specific integrated circuit, programmable logic device, and/or field programmable gate array. The memory 106-1 is an example of a non-transitory computer readable storage medium tangibly embodied in the controller 106 including executable instructions stored therein, for instance, as firmware. The communication module 106-3 may implement one or more communication protocols as described in further detail herein.

The mobile device 108 and the controller 106 communicate with one another. According to one or more embodiments, the communication between the mobile device 108 and the controller 106 is done through other systems such as transmitters, converters, receivers, and other transmitting and processing elements depending on the communication type selected. For example, the mobile device 108 and the controller 106 may communicate with one another when proximate to one another (e.g., within a threshold distance). The mobile device 108 and the controller 106 may communicate over a wireless network, such as 802.11x (WiFi), short-range radio (Bluetooth), or any other known type of wireless communication. In some embodiments, the controller 106 may include, or be associated with (e.g., communicatively coupled to) a networked element, such as kiosk, beacon, hall call fixture, lantern, bridge, router, network node, etc. The networked element may communicate with the mobile device 108 using one or more communication protocols or standards. For example, the networked element may communicate with the mobile device 108 using near field communications (NFC), or any type of known wired or wireless communication means. According to one or more other embodiments, the networked element may communicate with the mobile device 108 through a cellular network or over the internet through a number of other devices outside the building.

In other embodiments, the controller 106 may establish communication with a mobile device 108 that is outside of the building 102. This connection may be established with various technologies including GPS, triangulation, or signal strength detection, by way of non-limiting example. The communication connection that can be established includes, but is not limited to, a cellular connection, a WiFi connection, a Bluetooth connection, a peer-to-peer connection, a satellite connection, a NFC connection, some other wireless connection, and even a wired connection using an Ethernet cable, coaxial cable, or other data cable. These communication connections may transport data between the mobile device 108 using a number of different networks ranging from a private secure direct communication link to transporting the data over the internet through multiple different servers, switches, etc. Such technologies that allow early communication will provide users and the systems more time to establish the most efficient passenger flow, and may eliminate the need for a user to stop moving to interact with the system.

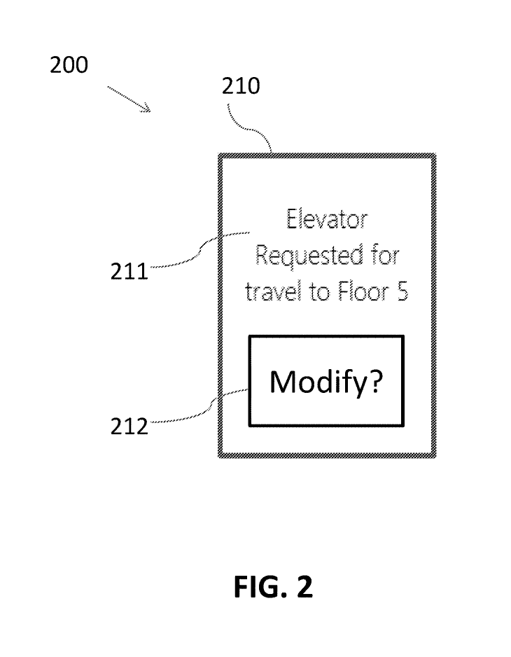

Implementation of a method and system of modifying an elevator call with a mobile device using the mobile device, controller, and elevator is described with reference to FIGS. 2-5.

Referring to FIG. 2, a graphical user interface (GUI) 200 for viewing a current elevator call and selecting to modify that elevator call with a mobile device 108 is shown according to one or more embodiments. The GUI 200 includes at least a screen 210 that indicates to the user their currently processing request 211. The interface indicates that a request for the elevator was made by the user and indicates the desired destination indicated by the user, as shown in 211. Additional information of any type may also be displayed on the screen. The GUI 200 also provides the user with the option to modify the request described on the screen by selecting the “Modify?” button 212 on the screen. In other modifications, this “Modify?” button would be visible until just before the elevator's arrival at the initially requested floor, ensuring modifications are made prior to the elevator stopping unnecessarily. In some embodiments, the button 212 on the screen may display any other desired text. According to other embodiments, the button 212 may instead be specific modification option so that a user can modify their original call with a single touch. For example, if the user typically travels to a particular floor, the “Modify” button 212 might indicate that floor and allow the user to modify the elevator call to travel to that floor. In embodiments of the elevator system where the user is able to enter a number of passengers that will be participating in the elevator call, the “Modify” button 212 might enable the user to input a new number (or enter for the first time) passengers that will be using the elevator.

According to other embodiments, the user may provide a modification selection through other input methods such as a verbal command or a gesture. For example, according to one embodiment, a user may see the GUI 200 requesting a modification input on their mobile device 108. The user can then shape the phone side to side which can indicate no desire to modify or can shape the up and down indicating a desire to modify. According to another embodiment, the user can flick there phone forward away from them which can indicate a specific modification request such as increasing the building floor or number of accompanying passengers. Similarly, a flicking motion toward the user could indicate a desire to decrease a value. According to other embodiments, a number of different gestures can be envisioned that can signify different modification requests.

Further, according to another embodiment, a user can enter a programming mode that allows a user to enter a gesture, verbal command, or other input and then define what that input should modify. For example, a user can record a verbal input of “my boss's office” and would define that modification as one that changes the destination to the floor on which the user's boss is located.

According to another embodiment, a more detailed example could be envisioned being used by a delivery service provider who could enter a verbal command consisting of a business name and the elevator call would be modified to the appropriate floor on which that business is located. Further, the delivery person who verbally input a string of verbal commands that could program a reserved freight elevator to travel to each of the requested business in the order entered in the verbal command. Other embodiments and variations can be envisioned that allow a user to provide different inputs to modify an elevator call.

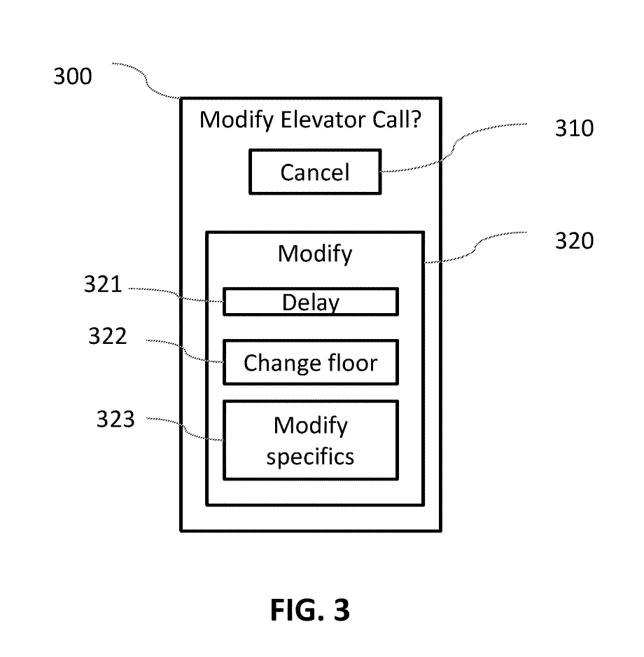

Referring to FIG. 3, a graphical user interface (GUI) for modifying an elevator call with a mobile device is shown according to one or more embodiments. As shown, upon selecting to modify the elevator call, the user is provided a screen 300 with several modification options. These options include cancelling the call, by selecting the “Cancel” button 310 or modifying the call through a number of possible options 320 such as delaying 321, changing destination 322, and/or other adjustments 323. According to another embodiment, additional modification options can be included or removed. For example, a user may provide a custom modification button that can change multiple call properties at once with the touch of the single modification button. According to another embodiment, a user may be provided the screen 300 initially.

As shown, the user may delay their desired pick-up by the elevator, by selecting the “Delay” button 321. In additional modifications, another interface might appear that allows the user to select their desired delay time in seconds or minutes. In some embodiments, there may be a time limit on the length of time for which the user can delay the elevator call. For example, in one embodiment, the maximum possible delay time may be one minute. In one embodiment, the maximum possible delay time may be greater than or less than one minute.

Another modification the user may make is to change their destination floor by selecting the “Change Floor” button 322. In some modifications, another interface might appear that allows the user to change the floor from which they will be picked up. In other modifications, another interface might appear that allows the user to change their desired destination floor. In other modifications, another interface might appear that allows the user to change either their pick-up floor and/or their destination floor.

Another modification the user may make is to modify specifics to their request, by selecting the “Modify Specifics” button 323. In some modifications, this may include but not be limited to preferences for quantity of additional stops made after pick-up.

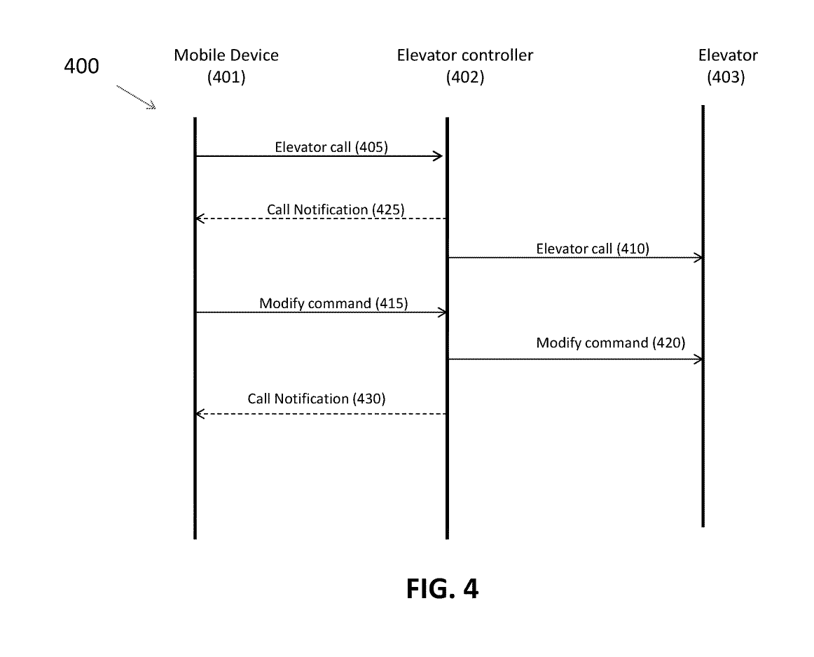

FIG. 4 depicts a transmission diagram 400 for controlling an elevator in accordance with the call and modification placed by a mobile device in accordance with one or more embodiments of the present disclosure. The transmission diagram 400 includes a call made from a user's mobile device 401 to the elevator controller 402 (operation 405). A call notification (operation 425) is an optional operation that would then be delivered from the elevator controller 402 to the user's mobile device 401, providing confirmation that the initial elevator call was received.

Next, the elevator controller (402) calls the elevator (403) through operation 410. In other modifications, the elevator controller 402 first decides the specific elevator to be called for this request and then makes the call to the specific elevator 403 to meet this request.

Once the elevator 403 has been called, the modification option becomes available to the user on their mobile device 401 and they are able to send a modification command (operation 415) to the elevator controller 402. In some embodiments, the modification option becomes available to the user on their mobile device 401 as soon as the elevator call (405) is placed. Upon receipt of a modification command (operation 415) from the user's mobile device 401, the elevator controller 402 sends a modification command (operation 420) to the elevator 403 with the revised elevator call instructions or details. A call notification (operation 430) is an optional operation that would then be delivered from the elevator controller 402 to the user's mobile device 401, providing confirmation that the modification command was received and the details of the modification implemented by the elevator 403.

According to another embodiment, a user may initial enter their elevator call using a kiosk. Once entered the user may decide to modify their elevator call for a number of reasons such as changing their mind or because the kiosk did not provide the specific option the user would like. Accordingly, the user would view the modification GUI on their mobile device based on the entry made at a kiosk. The kiosk entry can be attributed to the specific user by a number of different methods. For example, according to one embodiment, the kiosk entry can be associated with a specific mobile device that is nearest the entry pad on the kiosk. According to another embodiment, the kiosk may require a user specific key be entered that identifies the user and associated mobile device. According to another embodiment, the kiosk may be other sensors such as facial recognition sensors, fingerprint scanners, or other identification systems that can identify who is entering a request on the kiosk. Once the kiosk entry is receive and associated with a specific user device, the modification GUI is displayed on the mobile device. Accordingly, in this embodiment, a user can then user their mobile device to adjust, change, or even cancel the call they made initially at a kiosk.

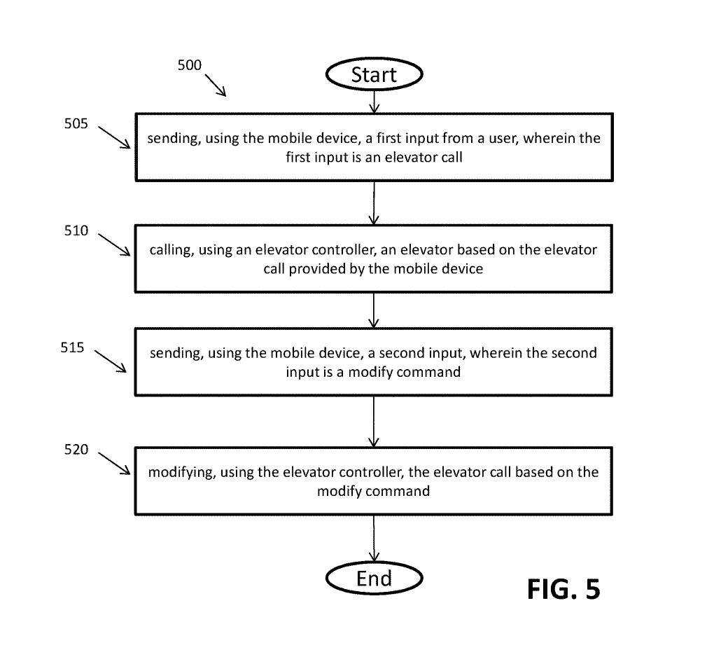

FIG. 5 depicts a flow diagram of a method 500 of modifying an elevator call with a mobile device in accordance with one or more embodiments of the present disclosure. The method includes sending, using the mobile device, a first input from a user, wherein the first input is an elevator call (operation 505). The method includes next calling, using an elevator controller, an elevator based on the elevator call provided by the mobile device (operation 510). The method includes next sending, using the mobile device, a second input, wherein the second input is a modify command (operation 515). The method includes next modifying, using the elevator controller, the elevator call based on the modify command (operation 520).

According to one or more embodiments, the modify command includes one or more of a call delay, a party number adjustment, a priority adjustment, a load size requirement adjustment, and/or a weight adjustment. The call delay is a time value that is used to delay the elevator call by the value stored. For example, a use who is moving slowing or had to make an extra stop on the way to the elevator can modify the call by selecting a call delay that could delay the elevator call by a few seconds, minutes, or longer. The modify command can also include a party number adjustment that when selected modifies the elevator call to request for a different number of people that are part of a defined party. Further, the modify command may include a priority adjustment. For example, for people who are granted to ability to priority their elevator calls by building management, could modify their elevator call to receive different levels of priority. For example, in a hospital setting when an emergency situation occurs, medical staff personnel that are cleared to make such a request can increase the priority of their elevator call to receive immediate accommodations. This can be done by delaying or even cancelling other elevator calls that are queued up for a specific elevator car. Further, the modify command could be modified to provide the load size requirement adjustment. For example, a person can request an elevator and then modify the request to indicate that the user has an additionally large load that would require special treatment and possible a specific elevator for freight. For example, a user moving furniture could modify their call accordingly to indicate the need for additional capacity in an elevator call and possible the need for a specific elevator. Further, another example includes a modify command that includes a weight adjustment which can be used to better provide elevator service based on the weight of the user and any cargo or party members that may be included.

According to another embodiment, the first elevator call from a mobile device could be deleted from the dispatching queue based on a modification command provided by a user. However, the hall call associated with the original elevator call would be retained so that other individuals who have subsequently arrived at the elevator landing and saw the hall button light already on would still be able to board an elevator traveling in the desired direction. The benefit would be that the mobile device user's first elevator call destination would not be entered as a car call since the mobile device user modified the request by cancelling and deleting it.

According to one or more embodiments, modification of a call may result in the system retracting the elevator command to pick up at the source floor location if there are no other calls from that source. Alternatively, according to another embodiment, if the car has arrived at the source floor or is on its way to the destination, the destination command is retracted. This is done if there are no other calls for that destination. Doing so helps avoid energy use for extra elevator travel.

According to another embodiment, if the elevator is already serving the call and is modified, implementing the modification can include effectively making a new dispatching decision for the whole elevator group. For example modification can include modifying the source or destination of that elevator, or deciding to send a different elevator.

According to another embodiment, a notification to a user with travel changes can be provided to the user if the system ever re-dispatches based on changes from any other users. According to another embodiment, a destination command may not be served if an expected passenger does not board the elevator and no one else is traveling to that destination.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable program instructions may execute entirely on the user's mobile device, partly on the user's mobile device, as a stand-alone software package, partly on the user's mobile device and partly on a remote computer or entirely on the remote computer or server. In the latter scenario, the remote computer may be connected to the user's mobile device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

1. A method of modifying an elevator call with a mobile device, the method comprising:
sending, to an elevator controller, a first input wherein the first input is a first elevator call;
calling, using the elevator controller, an elevator based on the first elevator call and the mobile device;
sending, using the mobile device, a second input, wherein the second input is a modify command; and
modifying, using the elevator controller, the first elevator call based on the modify command;
wherein the modify command includes one or more of a call delay, a party number adjustment, a priority adjustment, a load size requirement adjustment, call cancellation and a weight adjustment.

2. The method of claim 1, wherein the first input from a user is received using at least one from a group consisting of the mobile device, a kiosk, a web portal, and a detected input within a building using building sensors.

3. The method of claim 1, wherein the modify command includes a floor change.

4. (canceled)

5. (canceled)

6. The method of claim 1, wherein modifying the first elevator call comprises:
deleting the first elevator call from a dispatching queue in the elevator controller.

7. The method of claim 1, wherein modifying the first elevator call comprises:
modifying the first elevator call placement in a dispatching queue in the elevator controller.

8. The method of claim 1, wherein modifying the first elevator call comprises:
modifying one or more fields in the first elevator call while maintaining position of the first elevator call in a dispatching queue in the elevator controller.

9. The method of claim 1, further comprising:
notifying a user, using the mobile device, of an ability to modify the first elevator call.

10. The method of claim 1, further comprising:
notifying a user, using the mobile device that modifying the first elevator call is complete.

11. The method of claim 1, further comprising:
notifying a user, wherein notifying comprises:
generating a graphical user interface (GUI) that includes a modification notification and modification input fields,
wherein the modification notification includes at least one from a group consisting of a word, phrase, graphic, symbol, and image, and
wherein the modification input fields includes at least one from a group consisting of hyperlinked text, input buttons, and input fields; and
displaying the GUI on the mobile device.

12. A system for modifying an elevator call with a mobile device, the system comprising:
an elevator controller configured to receive a first input, wherein the first input is a first elevator call, and a second input, wherein the second input is a modify command, process the first input and second input, and transmit commands to an elevator based on the first input and the second input; and
a mobile device comprising:
an input device configured to receive the second input; and
a transmitter configured to transmit the second input; and
the elevator configured to receive the commands from the elevator controller and move in accordance with the received commands;
wherein the modify command includes one or more of a call delay, a party number adjustment, a priority adjustment, a load size requirement adjustment, call cancellation and a weight adjustment.

13. The system of claim 12, wherein the first input from a user is received using at least one from a group consisting of the mobile device, a kiosk, a web portal, and a detected input within a building using building sensors.

14. The system of claim 12, wherein the modify command includes a floor change.

15. (canceled)

16. (canceled)

17. A computer program product for modifying an elevator call, the computer program product comprising a computer readable storage medium having program instructions embodied therewith, the program instructions executable by a processor to cause the processor to:
receive, at an elevator controller, a first input, wherein the first input is a first elevator call;
call, using the elevator controller, an elevator based on the first elevator call and a mobile device;
receive, using the mobile device, a second input, wherein the second input is a modify command; and
modify, using the elevator controller, the first elevator call based on the modify command;
wherein the modify command includes one or more of a call delay, a party number adjustment, a priority adjustment, a load size requirement adjustment, call cancellation and a weight adjustment.

18. The computer program product of claim 17, the computer program product comprising additional program instructions executable by the processor to cause the processor to:
delete the first elevator call from a dispatching queue in the elevator controller.

19. The computer program product of claim 17, the computer program product comprising additional program instructions executable by the processor to cause the processor to:
modify one or more fields in the first elevator call while maintaining position of the first elevator call in a dispatching queue in the elevator controller.

20. The computer program product of claim 17, the computer program product comprising additional program instructions executable by the processor to cause the processor to:
notify a user, wherein notifying comprises:
generating a graphical user interface (GUI) that includes a modification notification and modification input fields,
wherein the modification notification includes at least one from a group consisting of a word, phrase, graphic, symbol, and image, and
wherein the modification input fields includes at least one from a group consisting of hyperlinked text, input buttons, and input fields; and
display the GUI on the mobile device.

21. The method of claim 1, wherein the modify command is received from a user before the user enters an elevator car.
